(19) United States
(12) Patent Application Publication
(10) Pub. No.: US 2018/0290767 A1
(43) Pub. Date: Oct. 11, 2018

(54) Satellite Launcher And Method For Putting Satellites Into Orbit Using Said Satellite Launcher

(71) Applicant: ZERO 2 INFINITY SL, Barcelona (ES)

(72) Inventor: Jose Mariano LOPEZ-URDIALES, Barcelona (ES)

(73) Assignee: ZERO 2 INFINITY SL, Barcelona (ES)

(21) Appl. No.: 15/762,579

(22) PCT Filed: Sep. 23, 2015
(86) PCT No.: PCT/EP2015/071892

§ 371 Date: Mar. 23, 2018

(51) Int. Cl. B64G 1/00; B64G 5/00; B64G 1/40

(52) U.S. Cl. CPC B64G 1/005; B64G 2005/005; B64G 1/402; B64G 5/00

(57) ABSTRACT

The satellite launcher comprises a plurality of stages detachable from each other, at least one stage including at least one engine, and at least one of said stages carrying a payload, and said stages are placed one beside or around the other, so that the width of the vehicle is at least one third of its length.

The method comprises the following phases: a) ascent of the vehicle with a balloon from a ship; and b) ignition of engines of the vehicle to put a satellite placed in the vehicle into orbit.

The present invention refers to a satellite launcher and to a method for putting satellites into orbit using said satellite launcher, in particular for putting microsatellites into orbit, i.e. satellites with a weight lower than 200 kg (441 lbs).

### BACKGROUND OF THE INVENTION

The traditional method to put microsatellites into orbit using conventional launch vehicles is very costly. These launchers were not designed for microsatellites. To make the launch worth, microsatellites accompany larger payloads as secondary payloads, a method akin to hitchhiking. By this way, it is not possible to select neither the orbit altitude and inclination nor the launch date. This implies long waiting times to get the satellite working, even if the launch itself as a secondary payload may be economical, the hidden cost of keeping teams together during the long waiting periods, combined with the inefficiencies of being placed in a suboptimal orbit, have so far restrained the development potential of nano and microsatellites.

Launching as secondary payloads also limits the components that can be included in the small satellite, only components approved by the insurer of the main, or primary, satellite will get to fly.

Thanks to advances in materials and electronics, nowadays, the performance of a satellite is more proportional to its area than to its weight. Available power is proportional to solar panel area. Communications gain is proportional to antenna area. Optical resolution of a telescope for remote sensing is proportional to mirror area. Modern high strength to weight materials, analysis methods and 3D printing now allow satellite designers to conceive systems with large areas and low weight, but they would not fit into a standard secondary payload container, nor inside the fairing of a slender air or ground launched rocket.

Only from the high altitudes where stratospheric balloons fly, where the atmosphere is no longer dense, one could launch such low density high performance small satellites.

Stratospheric balloons were used by scientists and engineers as reliable platforms to carry cosmic ray and astronomical observation equipment above 99% of the atmospheric mass during the early years of the second half of the 19th century (see Michael S. Smith and Greg Allison, “The Return of the Balloon as an Aerospace Test Platform”, Paper at the AIAA International Balloon Technology Conference, 28 Jun.-1 Jul. 1999, Norfolk).

In some cases, rockets where lofted with balloons to reach even higher altitudes. For example, Project Farside consisted in a four-stage vehicle using solid-propellant rockets; the missile was lifted by a balloon to an altitude of 30 km (100,000 ft) where it was fired through the balloon. (See James L. Rand, “Balloon Assisted Launch to Orbit an Historical Perspective”, AIAA, 1997, San Antonio, and William R. Corliss, “NASA Sounding Rockets, 1958-1968”, The NASA Historical Report Series, Washington D.C., 1971).

The use of a balloon was also explored as the only possible technological option to lift a rocket off from the surface of Venus, within the Venus Surface Sample Return project in order to reduce the weight and dimensions of the rockets needed to overcome the denser part of the Venus atmosphere. (See Ted Sweetser et al., “Venus Surface Sample Return: A Weighty High-Pressure Challenge”, Paper at the AAS-AIAA Conference in Alaska, August 1999).

These forerunner projects started to gain some of the benefits of the combination of a rocket and a balloon, which is often referred to as “rockoon”, but not all. The use of a high altitude balloon to launch the vehicle enhances the altitude that a given rocket can reach. It also avoids the use of the rockets during travel through the denser part of the atmosphere, resulting in a significant energy saving due to lower drag and smaller gravity losses. Furthermore, the ignition of the rockets in close-to-vacuum conditions increases the specific impulse of the rocket engine. But the rockets they were using were not designed for flight in very low density air, they were all very slender rockets being launched from a balloon instead of the ground. Missiles travelling in the atmosphere have to be slender in order to be aerodynamically efficient, but this is not needed for a vehicle in which the velocity is acquired in vacuum. A rockoon can be blunt. This invention describes the advantages of not just balloon assisted rocket launch per se, but also the use of blunt rockets, which are specifically suited to be launched from high altitude (they would not work well at sea level or at the altitudes that aircraft fly) and that takes much more advantage of the differences between sea level and the environment where the balloon takes the vehicle to.

U.S. Pat. No. 4,901,949 (Antonio L. Elias) discloses an air launched rocket to send payloads to orbit. Also companies like Virgin Galactic and Swiss Space Systems (s-3) intend to use aircraft as first stage. The USAF used an F15 to send an anti satellite weapon to orbit. All these projects used airplanes, not balloons, and airplanes fly in much denser layers of the atmosphere than balloons, so their rockets still have to be slender, otherwise they would generate a great amount of aerodynamic forces and torques on the aircraft making flight not possible.

One of the modern developments that makes this more feasible is the high degree of precision in trajectory prediction of high altitude balloons. Nowadays they can be predicted with similar error to that of a solid first stage rocket, and a boat can be placed in the location so that the balloon reaches the separation altitude in the coordinates that are optimal for the specific orbit we intend to reach.

There have been other proposals of rockoons, such as that in U.S. Pat. No. 7,131,613 B2, which discloses high-altitude launching of rockets lifted by helium devices and platforms with rotatable wings. In said document, the use of zeppelins with conventional rockets is disclosed, not free balloons with blunt rockets.

There is a clear emergence in small satellites (<200 kg or 441 lbs), which, in just one year (2014), increased by 400% the four-year forecast of satellite launches. The increase in performance of microsatellites sets the conditions for a disruption in the Space industry. There is a sort of Moore's law in performance of components from which these microsatellites are made.

The lower cost of microsatellites (several orders of magnitude lower than a conventional satellite of higher weight but same performance) will open Space to a wider range of institutions creating the future Space applications based society. The most promising microsatellite-enabled solutions require the satellites to be in constellations, which are sets of orbits that have certain geometric properties of value (such as constant coverage of an area, or a certain time between re-visits). For this to happen, the basic tool that will empower microsatellites to perform at their full potential is a dedicated microsatellite launcher.

Using microsatellites has many advantages, including:
Heavier satellites require larger rockets with greater thrust, environmental impact and cost.
Cheaper designs.
Ease of mass production using components from automobile and smartphone industries.
Possibility of placing constellations.
Responsive access.
Quick turn around and iterations of designs.
Use formations of microsatellites to gather information from multiple points.
Capable of performing in-orbit inspection of larger satellites.
Useful for university-related research.

### SUMMARY OF THE INVENTION

With the vehicle and the method according to the invention said drawbacks can be solved, presenting other advantages that will be disclosed hereinafter.

According to a first aspect, the satellite launcher according to the invention comprises a plurality of stages detachable from each other, at least one stage including at least one engine. All or some of the stages fire in parallel, the ensemble not being slender, but being blunt, that is its width is similar or greater than its length. In the preferred embodiment one of said stages is a central stage which is surrounded by one or more additional torus-shaped stages. However, other blunt configurations of stages are also possible according to the vehicle of the present invention. It must be pointed out that in this description and in the attached claims “length” must be interpreted as the movement direction of the vehicle, and “width” is the perpendicular direction with respect to the “length”.

Furthermore, at least one of the stages comprises at least one tank, and according to one embodiment, each stage comprises at least one tank and at least one engine.

Advantageously at least some of the tanks of stages are torus-shaped tanks, and the, or each, additional stage comprises a plurality of engines equidistantly spaced apart defining a circle.

According to a preferred embodiment, the payload is attached to the central stage. During the early phases of the flight the payload is protected by a fairing, which can be attached to any of the stages. In some embodiments the fairing is detachable, in others it is retractable.

Preferably, the first stage to detach is the outer one and inner ones detach in succession and the tank of at least one stage is connected to at least one engine of another stage, particularly the tank of the most external stage is connected to the engines of this stage and to the engines of the rest of stages.

According to a second aspect, the method for putting satellites into orbit using said satellite launcher comprises the following phases:

a) ascent of the vehicle with a balloon from a ship; and
b) ignition of engines of the vehicle to put a satellite placed in the vehicle into orbit.

According to a preferred embodiment, the ascent of the balloon with the vehicle takes from 80 and 100 minutes and places the vehicle at an altitude from 15 and 25 km (50,000 and 83,000 ft), and the ignition of the engines of the vehicles comprises at least the following steps:
a first step for placing the vehicle at altitude of about 80 km (263,000 ft or 50 mi), detaching a first stage of the vehicle;
a second step for placing the vehicle at an altitude of about 300 km (1,000,000 ft or 187 mi), detaching a second stage of the vehicle;
a third step for orbiting the satellite at an altitude of 600 km (2,000,000 ft or 373 mi) performing several fires and detaching the central stage from the satellite.

Preferably, the first step lasts about 120 seconds and it takes the vehicle at an inertial speed of about 3 km/s (6,711 mph), the second step lasts about 150 seconds and it takes the vehicle at an inertial speed of about 5 km/s (11,185 mph), and the third step comprises several fires and coasting periods to reach the required orbital velocity of 7.6 km/s (17,000 mph).

The present invention has at least the following advantages:

Easier integration: it is easier to integrate the stages and the payload horizontally than with a thin and slender rocket, which needs to be either erected after horizontal integration, or housed in a very tall enclosure for integration.

Increase of volumetric capacity: The payload can have larger size, for equal weight. It can be hosted in a wider fairing, since the vehicle does not have to be slender. In the prior art, microsatellites had to fit into a small volume (either because they are constrained by the volume of small fairing of a slender rocket, or because they have to fit in standard containers for secondary payloads. A slender body is a requirement for any launcher that needs to go through the lower and denser layers of the atmosphere at high speed without prohibitive drag losses. But slender tanks are volumetrically inefficient (they weigh a lot for the amount of propellant they carry). The weight of the tank comes from the structural weight and also the insulation weight (this is more important for cryogenic propellants).

After separation, instead of having the rocket fly through the balloon (as e.g. in project Farside), the rocket avoids the balloon and the balloon then flies up higher (it's like it dropped some ballast so it stabilizes at a higher altitude) and it can be used as a telecommunications relay from the ship to the rocket stack and the stages during re-entry. This way, you do not need a boat or ground station to communicate with the launcher in its initial phase, thus reducing cost and complexity.

Dedicated microsatellite launcher: The microsatellite does not reach the orbit as a secondary payload, thus being able to decide the date and/or the orbit altitude.

Adapted nozzles: Their performance is at the optimum point adapted to vacuum conditions. When a nozzle is adapted for low exterior pressure it needs to have a very large area, which is not compatible with slender missile shape rockets. By being blunt you can accommodate a much larger exit area for the rockets, increasing the efficiency of the propulsion.

Security: The blast radius in case of a catastrophic failure is far away from human life. This would not be the case of a rocket being fired from a crewed airplane. In the present invention, humans are 10s of kilometers away from the rocket ignition.

The shockwave during the re-entry is very far away from the body of blunt shape of the stages, for instance for annular stages, that is, there is a large standoff distance. This shape generates a high amount of drag which slows down the stages as they re-enter. A blunt body spreads the heat over a wider area than a slender one, acting as an effective heat shield thus allowing a lighter structure of the vehicle. This makes recovery of the stages easier. This potential for recovery, refurbishment and reusability could eventually reduce the cost of launch.

Decrease of vibrations and sound pressure due to ignition of engines at high altitude instead of on the ground.

The vehicle can be pressure fed, with low tank weight and high efficiency in the engines, instead of pump fed. The pumps are one of the most expensive, prone to failure and heavy parts of a launcher.

Re-usability is easier, since the stages have been designed “for the way down” and not for “the way up” through the atmosphere, which is taken care of by the balloon.

### BRIEF DESCRIPTION OF THE DRAWINGS

For a better understanding of what has been disclosed, some drawings are attached, showing diagrammatically and only as a non-limitative example, one embodiment of the invention.

FIG. 1 is an exploded perspective view of the satellite launcher according to one embodiment of the invention;

FIG. 2 is an elevation view of the satellite launcher according to the preferred embodiment the invention;

FIG. 3 is an elevation view of a system for putting satellites into orbit used for the method according to the present invention;

FIG. 4 is a diagrammatical view of the flight train used in the system for putting satellites into orbit;

FIG. 5 is a diagrammatical view of the connections between the tanks and the engines of the aerospace according to the invention in three different phases during the method according to the invention; and

FIG. 6 is a diagrammatical view of the whole method for putting satellites into orbit according to the present invention.

### DESCRIPTION OF A PREFERRED EMBODIMENT

The present invention relates to a satellite launcher, specifically a suborbital and orbital launcher, and to a method for putting satellites into orbit using said vehicle.

The satellite launcher 10 according to the present invention comprises several stages which make up a blunt ensemble and are themselves blunt. In the preferred embodiment there are two torus-shaped stages and a central stage. These stages are detachable from each other during the method according to the present invention, as described hereinafter. These stages are preferably coated with adequate re-entry material, which could be ablative, such as phenolic resins or radiative such as carbon-carbon composites or carbon aerogels.

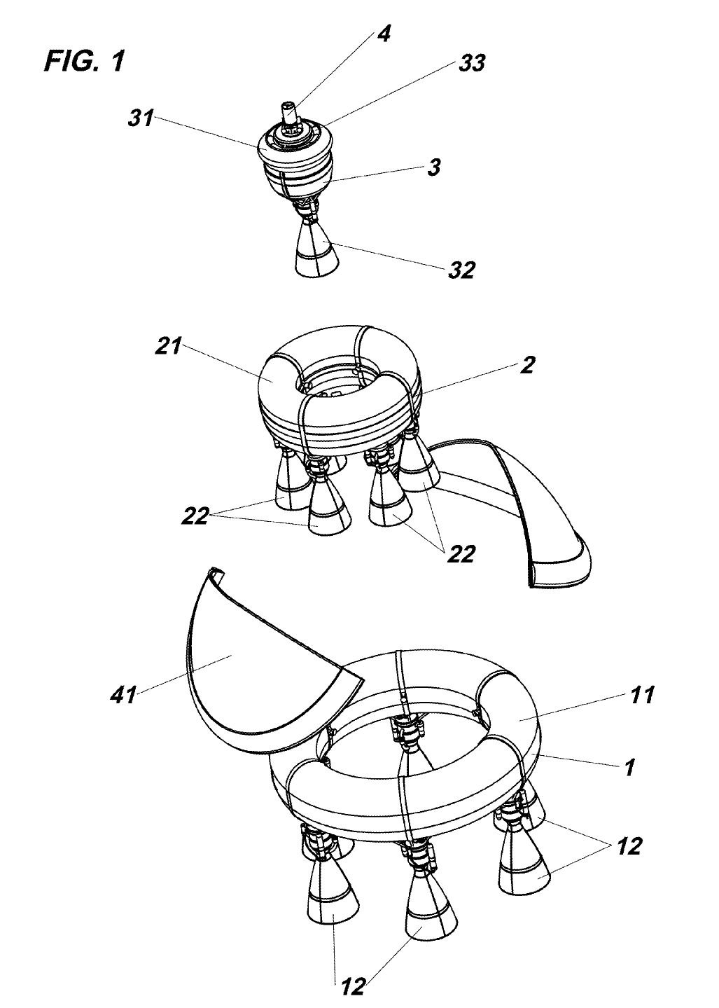

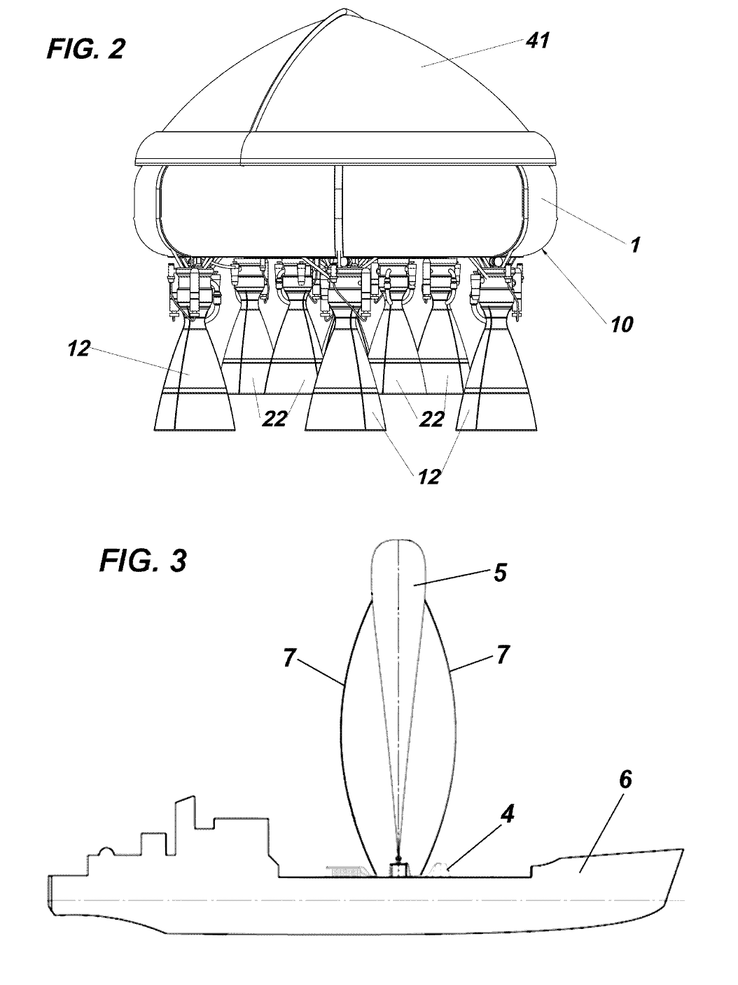

According to the embodiment of FIG. 1, a first stage 1 comprises a torus-shaped structural tank 11 and wraps a second stage 2, which also comprises a torus-shaped tank 21, and a third or central stage 3, which has an ellipsoidal tank 31. This configuration saves dry mass since all the engines can be ignited and contributing to the thrust during the whole trajectory.

Furthermore, the vehicle according to the invention uses composite tanks 11, 21, 31 that reduce weight, costs, from using conventional metal tanks.

All three stages 1, 2, 3 comprise corresponding engines 12, 22, 32, distributed in a ring-like symmetrical pattern in the first and second stages 1, 2, and a core engine 32 in the third stage 3. The propellants combination chosen to be used in the preferred embodiment is liquid oxygen and liquid methane. This bi-propellant combination is the perfect match between performance, simplicity of hydrocarbon combustion and green propulsion. This patent should cover other propellants, both monopropellant and bi-propellants.

Preferably, the engines 12, 22, 32 are pressurized by a suitable pressurant gas, such as Helium, either compressed, liquefied or enriched with reactants (as in the Tridyne method disclosed in U.S. Pat. No. 3,779,009 A). In another instance, the engines 12, 22, 32 are pressurized by a Vapor Pressurization (VaPak) system. The main advantage of the VaPak concept compared to alternative like inert gas pressurization or pumped-fed systems is its reduction in complexity and a reduction in empty weight. By using the VaPak system the vehicle according to the invention is expected to have a high performance while remaining a simple system.

Vapor Pressurization is based on the use of high vapor pressure of the propellants to provide the pressure difference required for the propellants to flow into the combustion chamber. The high vapor pressure is obtained from the internal energy of a liquid stored in a closed container. As propellant is drained, liquid boils, and resulting gas re-pressurizes the propellant tank. The pressurization system is used at every stage to pressurize the propellants tanks to a pressure large enough for the propellants to flow into the combustion chambers of the rocket engines.

Using a propulsion system based on green propellants and a first balloon ascent, as will be described hereinafter, with inert Helium, will mitigate the chemical contamination of traditional launchers due to the presence of ozone depleting chemicals on the rocket combustion products, which affect the ozone layer that protects all life forms from solar UV radiation.

The satellite launcher according to the present invention also comprises a GNC (Guidance, Navigation and Control) system 33 at least in the central stage 3, in which it is also placed a payload 4, protected by a corresponding fairing 41. This payload 4 includes the satellite. There is also a standard adaptor for the satellite to be attached and released from the central stage.

The compact configuration of the vehicle according to the invention makes control simpler than the one of traditional very slender bodies. The GNC system 33 calculates the optimum trajectory and controls the elements for modifying the trajectory. The software implemented would be capable of controlling the vehicle in the event of engine failure (the mission success is assured even in the event of a one-engine-out of the first stage and/or second stage), as will be explained hereinafter.

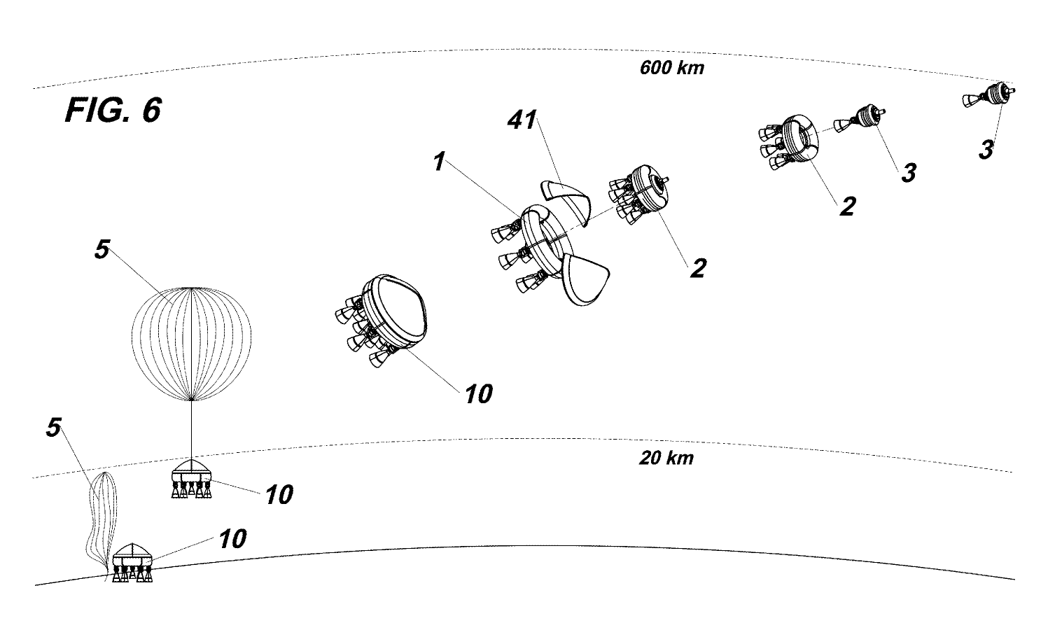

The method for putting satellites according to the invention comprises two different phases: balloon ascent and vehicle ignition, as shown in FIGS. 3 and 6.

The satellite launcher 10 according to the invention is preferably launched from a ship 6 reducing the risk of launch delays by avoiding bad weather and also compensating ground winds and adapting the engine ignition spot to mission and safety requirements.

The balloon 5 during the first phase of the flight cycle carries the vehicle according to the invention up to 20 km and the ascent lasts around 90 minutes. The balloon 5 will be filled with a suitable lifting gas through corresponding inflation tubes 7 such as Helium or Hydrogen. In one instance a hot air balloon may be used instead of a gas balloon.

The buoyancy effect takes the balloon 5 with the vehicle 10 to a predefined altitude between 20 km and 25 km. In case of a malfunction of the rocket or satellite prior to its detachment from the balloon, the whole mission could be aborted with recovery, since the balloon may controllably vent gas from its apex valve and descend to the sea where the payload and rocket may be re recovered for inspection or future re-flight.

The second phase of the flight cycle starts once the engines of the vehicle 10 are ignited, and it consists of several stage firings different steps (the exact values may change depending on the orbital destination of the flight, and this is just an illustrative case):

The first step lasts 120 seconds and it takes the vehicle 10 from 20 to 80 km (66,000 to 263,000 ft) at an inertial speed of 2.8 km/s (6,264 mph). During this step the engines of the vehicle 10 are producing thrust with a total vacuum impulse of 104 kN (23,380 lbf). The cover 41 that protects the payload 4 is detached, or retracted at about the same time that the first stage 1 separates from the rest of the vehicle.

The second step raises the vehicle 10 to 300 km (33,000 ft to 187 mi) in 150 seconds and the second stage 2 is detached, and at the end of this step the vehicle 10 is flying at an inertial speed of 5.1 km/s (11,500 mph). During the second step the engines of the vehicle 10 produce thrust with a maximum vacuum impulse of 14 kN (3,148 lbf).

The last step performs several fires to optimally orbit the payload 4. The first fire lasts for 100 seconds and allows the payload 4 to reach 600 km (373 mi) of altitude while still slightly below the target orbital speed. Then, the third stage 3 coasts for 200 seconds and a final fire of 145 seconds optimally orbits the payload 4. Lastly, the last boost of the third stage 3 is performed to detach and de-orbit the third stage 3 in order to minimize the amount of space debris left by the mission. This method is shown in FIG. 6.

The stages 1, 2, 3 may brake up in re-entry or may be recovered by having them either land on land or on a barge in the sea as originally described on the publication by Yoshiyuki Ishijima et al., “Re-entry and Terminal Guidance for Vertical-Landing TSTO (Two-Stage to Orbit),” AAIA Pub. No. 98-4120 in 1998. In both cases, a large net may be used to simplify the guidance requirements and have the stage just fall into the net, and not land as precisely as it would be required on a flat Helipad sort of surface. Using the net also saves on dry weight of the stages, since they would not require landing legs.

The main advantage of using a boat to launch a balloon is to balance the wind speed with the ship speed, so there is zero relative wind speed between the air and the balloon, which simplifies the operation. This also provides the flexibility to launch from most of the surface of the planet, which is covered by water, better meeting mission needs than launching from a fixed spaceport.

The ship, by moving at the same speed as the wind, creates a near zero wind column for inflating and releasing the balloon from the deck. The ship itself does not need any significant adaptation for the operation and any ship with a sufficiently big flat area to accommodate the bubble of the balloon being inflated, and with the right conditions for propellant storage, could be rented to perform the flight. The payload is mounted near the balloon inflation area.

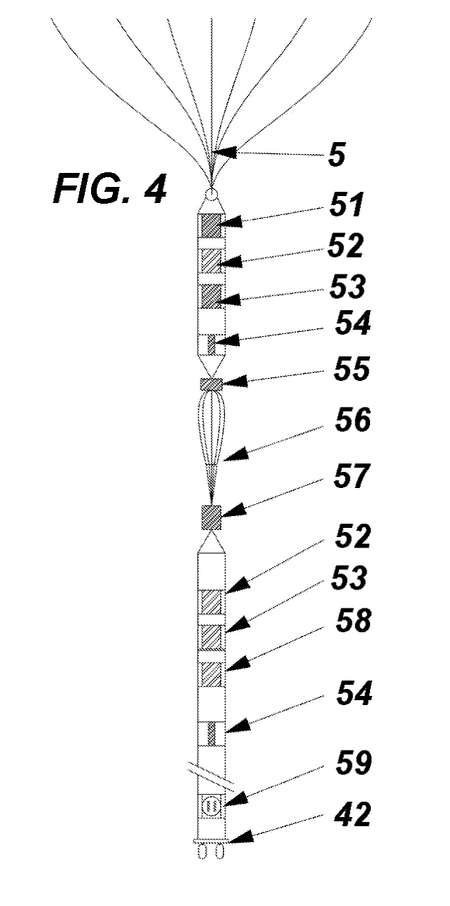

The balloon 5 also comprises a flight train and gondola that remain attached to the balloon and includes its own avionics system, shown in FIG. 4, which is responsible for sensing the motion of the vehicle, monitoring the subsystems state, communicating with ground and providing the computational power and internal communications for the GNC system 33 and subsystems interactions. The avionics system also supplies the necessary electrical power satisfying the need for high power when required and enabling ground to on-board switching. Communication between ground and the vehicle 10 is crucial during the mission; vehicle-to-ground communications provide data to the ground concerning real-time flight data towards vehicle on ground tracking and monitoring, and off-line data for post-mission exploitation; ground-to-launcher communications provide link to ground safety commands.

The flight train is located between the balloon 5 and the vehicle 10 and hosts all the necessary equipment for a successful balloon operation comprising at least the following elements:
a GPS 51 for detecting the position of the balloon 5;
one or more transponders 52 for coordination with Air Traffic Control;
one or more telemetry systems 53;
one or more radar reflectors 54 to comply with the Rules of the Air;
a flight termination system 55 to ensure separation of the payload;
optionally parachute 56 including a parachute releasing system 57 to recover the gondola and flight train in case of balloon failure;
a ballast machine 58 to precisely control the altitude;
a truck plate 59 to transmit the loads; and
a mechanical adaptor 42 to engage with the vehicle below 4.

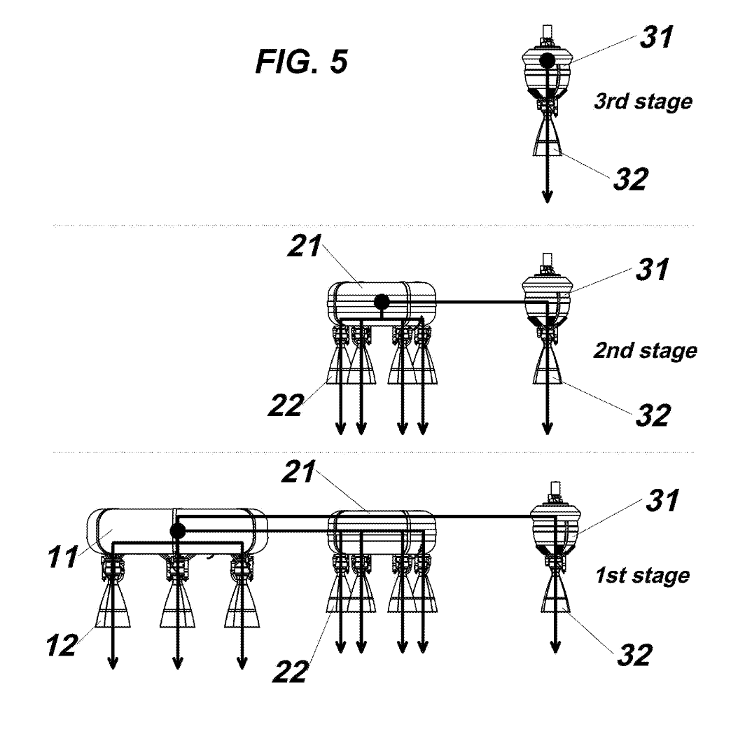

As shown in FIG. 5, in order to optimize the capabilities of the launcher, a cross-tanking capability would be implemented in some cases, so that the remaining stages are full when a stage separates, in the preferred embodiment this means having piping from the 1st to the 2nd and 3rd and from the 2nd to the 3rd. This piping disconnects (possibly by a normally open pyrovalve) when the separation takes place.

During the first step of the second phase of the method according to the invention, the engines 12, 22, 32 of the first, second and third stages 1, 2, 3 are fed by the tank 11 of the first stage 1.

During the second step of the second phase of the method according to the invention, the first stage 1 has been detached and the engines 22, 32 of the second and third stages 2, 3 are fed by the tank 21 of the second stage 2.

During the third step of the second phase of the method according to the invention, the second stage 2 has been detached and the engine 32 of the third stages 3 is fed by the tank 31 of the third stage 2.

A breakdown of the masses of each stage of the vehicle according to the invention is shown in Table I. The table also illustrates the ideal increment of velocity (deltaV) that every stage contributes to, this is an example, numbers may vary.

TABLE I
Masses breakdown

| | First stage | Second stage | Third stage |
|---|---|---|---|
| Structural mass (kg) | 552.7 | 118.8 | 103.7 |
| (lbs) | 1,219 | 261.9 | 228.6 |
| Fairing (kg) | 25 | 0 | 0 |
| (lbs) | 55 | 0 | 0 |
| Propellant mass (kg) | 3284.6 | 622.6 | 218.7 |
| (lbs) | 7,241.3 | 1,373 | 482.2 |
| Total stage mass (kg) | 3862.3 | 741.4 | 322.4 |
| (lbs) | 8,514.9 | 1,635 | 710.8 |
| Stage “Payload” (kg) | 1138.8 | 397.4 | 75 |
| (lbs) | 2,510.6 | 876.1 | 165 |
| Engine Isp (s) | 342 | 342 | 342 |
| Ideal deltaV (m/s) | 3587.8 | 2654.6 | 2681.4 |
| deltaV contrib. (%) | 40.2 | 29.8 | 30 |

Even though reference has been made to a specific embodiment of the invention, it is clear for a person skilled in the art that the disclosed system is susceptible of a number of variations and modifications, and that all the details mentioned can be substituted by other technically equivalent ones, without departing from the scope of protection defined by the attached claims.

1. A satellite launcher comprising a plurality of stages detachable from each other, at least one of said stages including at least one engine, and at least one of said stages carrying a payload, wherein said stages are placed either beside or around one another, so that the width of the vehicle is at least one third of its length.

2. The satellite launcher according to claim 1, wherein the width of the vehicle is the same or greater than the length of the vehicle.

3. The satellite launcher according to claim 1, wherein at least one of the stages comprises at least one tank.

4. The satellite launcher according to claim 1, wherein one of said stages is a central stage which is surrounded by one or more additional torus-shaped stages.

5. The satellite launcher according to claim 3, wherein each tank is a torus-shaped tank.

6. The satellite launcher according to claim 4, wherein each additional stage comprises a plurality of engines equidistantly spaced apart defining a circle.

7. The satellite launcher according to claim 1, wherein the payload is placed in the central stage.

8. The satellite launcher according to claim 6, wherein the payload is protected by a fairing which could be is either detachable or retractably attached to any of the stages.

9. The satellite launcher according to claim 4, wherein the central stage also comprises a guidance, navigation and control system.

10. The satellite launcher according to claim 3, wherein each tank is made of composite.

11. The satellite launcher according to claim 3, wherein the tank of at least one stage is connected to at least one engine of another stage.

12. The satellite launcher according to claim 4, wherein the tank of the most external stage is connected to the engines of this stage and to the engines of the rest of stages.

13. A method for putting satellites into orbit using the satellite launcher according to claim 1, wherein the method comprises the following phases:
a) ascent of the vehicle with a balloon from a ship; and
b) ignition of engines of the vehicle to put a satellite placed in the vehicle into orbit.

14. The method according to claim 13, wherein the ascent of the balloon with the vehicle takes from 80 and 100 minutes and places the vehicle at a height from 15 to 25 km (50,000 to 83,000 ft).

15. The method according to claim 13, wherein the ignition of the engines of the vehicles comprises at least the following steps:
a first step to place the vehicle at a height of about 80 km (263,000 ft or 50 mi), detaching a first stage of the vehicle;
a second step to place the vehicle at a height of about 300 km (1,000,000 ft or 187 mi), detaching a second stage of the vehicle; and
a third step to or the satellite at a height of 600 km (2,000,000 ft or 373 mi) performing several fires and detaching the central stage from the satellite.

16. The method according to claim 15, wherein the first step lasts about 120 seconds and it takes the vehicle at an inertial speed of about 2.8 km/s (6,264 mph).

17. The method according to claim 15, wherein the second step lasts about 150 seconds and it takes the vehicle at an inertial speed of about 5 km/s (11,185 mph).

18. The method according to claim 15, wherein the third step comprises a first fire that lasts from 90 and 110 seconds, and second fire that lasts from 180 and 220 seconds and a final fire that lasts from 140 and 160 seconds.
